(19) United States
(12) Patent Application Publication
(10) Pub. No.: US 2006/0212270 A1
(43) Pub. Date: Sep. 21, 2006

(54) Auditing of secure communication sessions over a communications network

(76) Inventors: Simon Shiu, Bristol (GB); Adrian Baldwin, Bristol (GB); Marco Casassa Mont, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/492,708

(22) PCT Filed: Mar. 17, 2003
(86) PCT No.: PCT/GB03/01151

§ 371 Date: Feb. 15, 2005

(30) Foreign Application Priority Data
Mar. 18, 2002 (GB) 0206406.1

(51) Int. Cl. G06F 11/00

(52) U.S. Cl. 702/188

(57) ABSTRACT

A method of auditing a communications session by using a secure device comprises: operating a communications protocol in said secure device; and producing an audit record of at least one transaction carried out by said secure device.

### FIELD OF THE INVENTION

The present invention relates to auditing of secure communication sessions over a communications network, and particularly, although not exclusively, to auditing of communications sessions established in a Secure Socket Layer (SSL) session.

### BACKGROUND TO THE INVENTION

As commerce is increasingly carried out over the internet, there is an increasing need for a non-repudiable audit trail for recording details of transactions. Ideally, such audit trails should not only keep internal application audit data in a way that its integrity can be proved, but it should also ensure that requests from users can be tightly linked to their authentication data.

It is known in prior art telephone based transactions, for example for stock trading between financial institutions, that all telephone calls are automatically recorded by a voice data recording apparatus, so that any disputes as to the timing or content of a transaction between parties can be resolved by referring to the recorded voice data after the event. The voice data is stored for a predetermined period, which is agreed between parties, allowing enough time for settlement and fulfillment of transactions, before the voice data is overwritten. In some systems, the voice data is archived and kept for a relatively long period, for example years before being overwritten or deleted. However, such a prior art system can not be adapted for internet use where commands and instructions are made in TCP/IP protocol, and an equivalent system applicable to internet sessions is not available in the prior art

In prior art internet based transaction systems, it is known for a user of a website to instruct a transaction, using a screen-based service served via a website. For example, in internet banking, a user, using a personal computer or similar computer, accesses a website which displays details of the users bank account. The user can instruct transfers into or out of the account, or set up standing orders, using a screen based interface display. Typically, in such prior art systems a user session is conducted using the prior art Secure Socket layer (SSL) protocol. Therefore, the user has confidence that the screen display is a display generated by the users bank, and the user has confidence that the instructions input by the user are being received by the banks website.

However, a problem occurs where a user gives instructions to a website, but those instructions are not carried out by a service provider operating the website, even though they are properly received within an SSL session. In the prior art system, the user may fail to keep a record of the instructions given, and the service provider may or may not keep a record of those instructions given. In the event of dispute over whether an instruction was given or not, and the precise content of that instruction, both the user and the service provider must rely upon their own records, of any are kept at all, to resolve the dispute.

In prior art internet based e-government systems, such as an on-line systems for filing a tax return, a user is supplied with software on a disk in order to fill in a tax return form, which is then transmitted to a government operated server computer which receives the electronic tax return. Tax returns have deadlines for submission to the government, and although the server retains a copy of the tax return, there is no mechanism for verification of the timing of submission of the tax return to the government server by the sending party.

Secure Socket Layer (SSL) has become a widely available method for securing websites and is also being used to provide secure channels over which programmatic requests via Soap are passed. SSL can provide two way authentication via PKI certificates, or more often, a server may be authenticated via PKI, and within a protected session, a user is authenticated to the session using a user name and pass word exchange.

Referring to FIG. 1 herein, a prior art one-way SSL session typically involves first and second modes each having a session key, and a key exchange occurs. A first user 401 has a digital certificate of a current key pair. The normal prior art way in which a digital certificate is used is that a web server 400 has a certificate, and a public/private key. This certificate will be used to secure the key exchange so that a session key is shared by both parties in the session. The session key is a symmetric key, for example a triple DES key. This key is then used to form a channel between the two entities. There are various check sums in the protocol, to ensure that the exchange of the session key occurs without error.

The SSL protocol ensures that any communications between the two entities are encrypted. Each entity has information on the identity of the other entity, because certificates are exchanged during the key exchange. This is referred to as ‘one-way SSL’.

Referring to FIG. 2 herein, a prior art ‘two-way SSL’ session involves first and second computer entity parties 500, 501 each initially having a separate key. Each entity exchanges its key with the other entity, so both entities have each other's keys. Each party stores information concerning the identity of the other party. The entities share a session key, so that any communications between the entities are guaranteed to be secure as between entities, because it uses the session key stored by both entities, and originating from the entities.

The problem with the prior art SSL protocol, is that although each computer entity can verify that it is dealing with a known other computer entity at the time of the session, there is no record to show retrospectively, after the session that a particular computer entity communicated with the other computer entity, even if the session key is stored. There is no non-repudiation system at all, and in theory, each computer entity could be manipulated to retrospectively create false information about the data content of commands exchanged during a session. The prior art SSL protocol goes as far as authentication of communicating entities at the time of the session, but does not provide any non-repudiation mechanism applicable retrospectively after a session for establishing without doubt, the content or timing of a session.

The SSL protocol itself is not designed to provide non-repudiation by linking a transmitted content together. As such, the known SSL protocol has some failings in a secure e-commerce, or e-government environment, since it does not provide a non repudiable medium.

The inventors have considered enhancing the prior art SSL protocol to include required properties to overcome some of the nonrepudiation problems with the prior art SSL protocol, or alternatively to design a new alternative protocol to SSL in order to provide an audit mechanism for e-transactions between computer entities over the internet. However, SSL is widely used, and there is a large installed base of computer entities already using SSL. Therefore introduction of a new version of SSL or an alternative protocol will prove difficult in practice, due to the large amount of legacy SSL operating computers in use, even though such a solution would be technically feasible.

### SUMMARY OF THE INVENTION

According to the first aspect there is provided a method of operating a secure communications session, said method comprising:
generating a unique identifier data identifying said communications session;
storing a first unique identifier data identifying a first computer entity, party to said communications session;
storing a second unique identifier data identifying a second computer entity party to said communications session;
monitoring data communications between said first and second computer entities; and
generating a data uniquely identifying said data communications between said first and second computer entities.

According to a second aspect there is provided a method of providing a verifiable record of a secure communication session between first and second computer entities party to said secure communications session, said method comprising;
receiving from said first computer entity a first set of data transmissions comprising said communications sessions;
receiving from said second computer entity a second set of data transmissions comprising said communications session;
storing said first set of data transmissions;
storing said second set of data transmissions;
generating a unique identifier data uniquely identifying said communication session;
generating a data uniquely identifying said first and second sets of data transmissions;
generating an audit record data uniquely identifying said communications session, said first and second computer entities and comprising said data uniquely identifying said data transmissions.

According to a third aspect there is provided a method of verifying a communication session between a first computer entity and a second computer entity, said method comprising:
during said communications session, storing data transmissions between said first computer entity and said second computer entity;
receiving a request data from a said computer entity, said request data comprising a pattern of data transmissions made by said computer entity;
comparing said pattern of said data transmissions with a pattern of data transmissions stored as said record of said communications session;
if said pattern of said received request matches a said pattern of said communications session, then generating a token data; and
sending said token data to said requesting computer entity.

According to a fourth aspect there is provided an apparatus for secure protocol management, said apparatus comprising:
a tamper proof container;
an input port and an output port, for connecting said device to a communications network wherein a secure communications session is transferred through said input and output ports;
a timer device for timing a secure communications session;
a key generator for generating at least one security key; and
a hash generator for generating a one-way hash function of data comprising a communications session, said apparatus operable for producing a record of said secure communications session.

In a further aspect, there is provided an audit record data file, for verifying a content of a secure communications session between a plurality of computer entities, said audit record data comprising:
data identifying said communications session;
data identifying a first computer entity involved in said session;
data identifying a second computer entity involved in said session;
data uniquely identifying a set of communications between said first and second computer entities; and
data identifying a timing of said communications between said first and second computer entities.

According to fifth aspect there is provided a method of configuring an apparatus for secure protocol management, said method comprising;
applying electrical power to said apparatus;
said apparatus generating a public/private key pair set, for use by said apparatus;
requesting a certificate from a third party computer entity;
receiving said certificate and storing said certificate;
said third party computer entity being identified in a pre-stored list of trusted computer entities.

According to a sixth aspect, there is provided a service method for producing a verifiable record of at least one communications session carried out by a computer entity having a secure communications capability, said method comprising:
connecting a monitoring device to said computer entity, for monitoring said at least one communications session carried out by said computer entity;
said monitoring device storing a record uniquely identifying said at least one communications session carried out by said computer entity;
after said at least one communications session has have been monitored by said monitoring device, carrying out an inspection of said monitoring device to ensure that said monitoring device has not been compromised; and
in response to a request for verification of said at least one communications session from a third party, issuing a statement verifying that said secure monitoring device has not been compromised.

Other aspects are as described in the claims herein.

### BRIEF DESCRIPTION OF THE DRAWINGS

For a better understanding of and to show how the same may be carried into effect, there will now be described by way of example only, specific embodiments, methods and processes according to the present invention with reference to the accompanying drawings in which:

FIG. 1 illustrates schematically a prior art secure socket layer (SSL) session of the one way SSL type;

FIG. 2 illustrates schematically a prior art two-way SSL session between two computer entities;

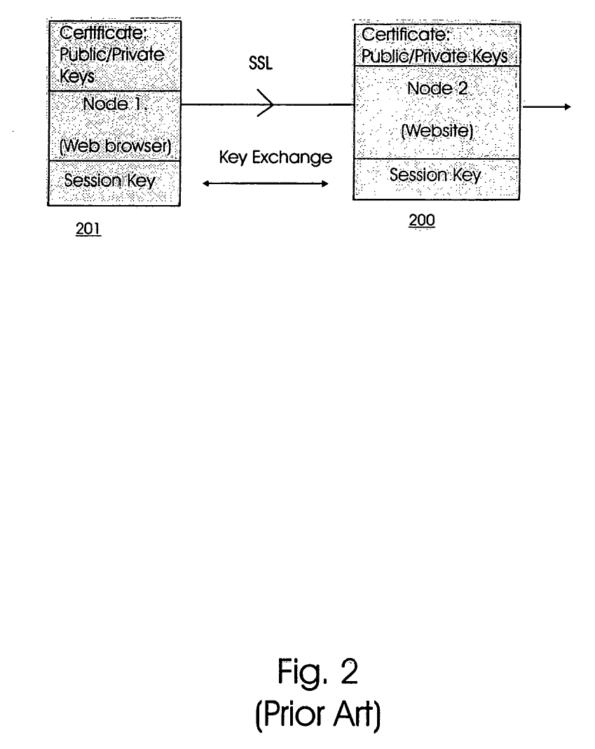

FIG. 3 illustrates schematically an on-line secure transaction system having a secure protocol manager device for generating a non-repudiable audit trail record of a session between a user computer entity and a web server computer entity;

FIG. 4 illustrates schematically individual components of each computer entity of FIG. 3;

FIG. 5 illustrates schematically components of a secure protocol manager device comprising the system of FIG. 3;

FIG. 6 illustrates schematically a logical relationship between a users web server computer entity, a secure protocol manager computer entity and a website server computer entity during a transaction session;

FIG. 7 illustrates schematically an inlitialisation phase of the secure protocol manager apparatus of FIG. 5, upon installation of that device into the system of FIG. 3;

FIG. 8 illustrates schematically in broad overview, communications between computer entities in the system, and processes carried out by each computer entity in the system during an audited transaction session;

FIG. 9 illustrates schematically individual command, message and response communications between computer entities as part of an audited transaction session;

FIG. 10 illustrates schematically a signed audit record, giving a non-repudiable record of commands, responses and messages exchanged within an audited transaction session;

FIG. 11 illustrates schematically a certified token issued by a secure protocol manager device of FIG. 5, to a computer entity engaged in an audited transaction session managed by the secure protocol manager device, and providing a non-repudiable token establishing details describing an audited transaction session; and

FIG. 12 illustrates schematically a method of managing a secure communication session between first and second server computer entities, involving a secure protocol management device, according to a third specific implementation.

### DETAILED OF A SPECIFIC MODE FOR CARRYING OUT THE INVENTION

There will now be described by way of example a specific mode contemplated by the inventors for carrying out the invention. In the following description numerous specific details are set forth in order to provide a thorough understanding. It will be apparent however, to one skilled in the art, that the present invention may be practiced without limitation to these specific details. In other instances, well known methods and structures have not been described in detail so as not to unnecessarily obscure the description.

Specific implementations herein aim to provide a system which allows a non-repudiable audit log to be created from an SSL session as well as allowing authentication tokens to be generated during the session. This authorisation can be used elsewhere in a system, or even in other independent systems. Specific implementations may also be applied to other protocols, where temporary 2-way authentication is achieved without concern for audit.

The specific implementations herein also aim to provide a system for providing a non-repudiable audit trail for requests made from SSL sessions linking a user's authentication with a remaining SSL session content. This should allow a secure website to create secure audit logs without the need to change the current SSL interaction models.

Specific implementations are concerned with providing a verifiable audit trail which allows a computer entity operating an SSL session to retain proof of user commands, and responses to those user commands, and to record a date and time of those commands and uniquely identify the commands and responses, thereby providing verifiable proof that the commands were received by the computer entity, and the responses were sent by the computer entity, in the context of an online environment.

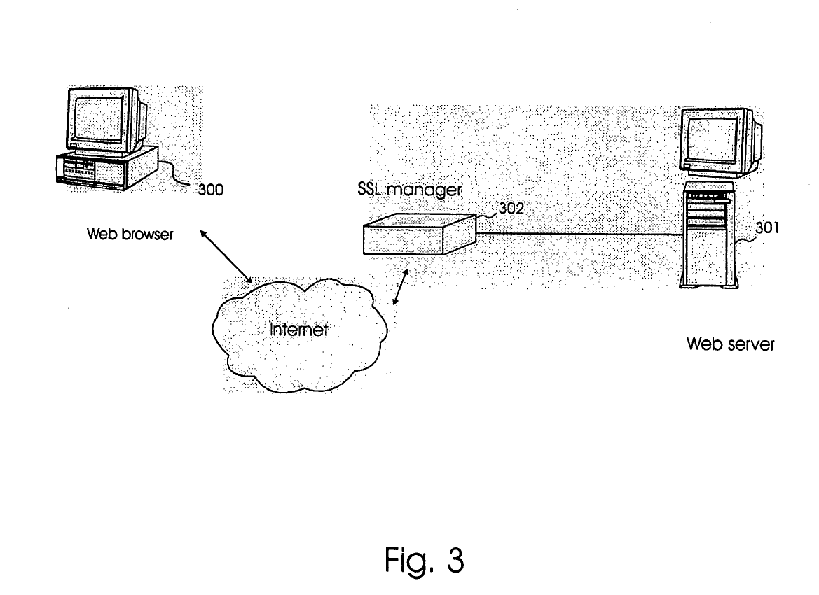

Referring to FIG. 3 herein, there is illustrated schematically an on-line transaction system comprising: a user computer entity 300 having a web browser and a secure socket layer protocol driver; a web server computer entity 301 for generating a web interface, through which the web server can communicate with the user computer entity, via a web browser on the user computer entity; and a secure protocol manager computer entity 302 for applying an audit trail to secure communications between the user computer and the web server computer 301.

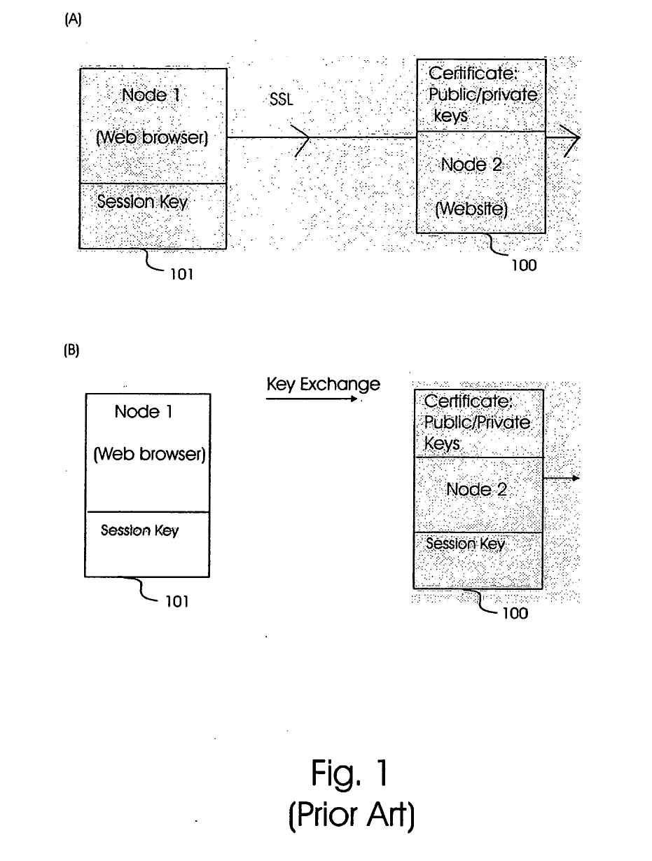

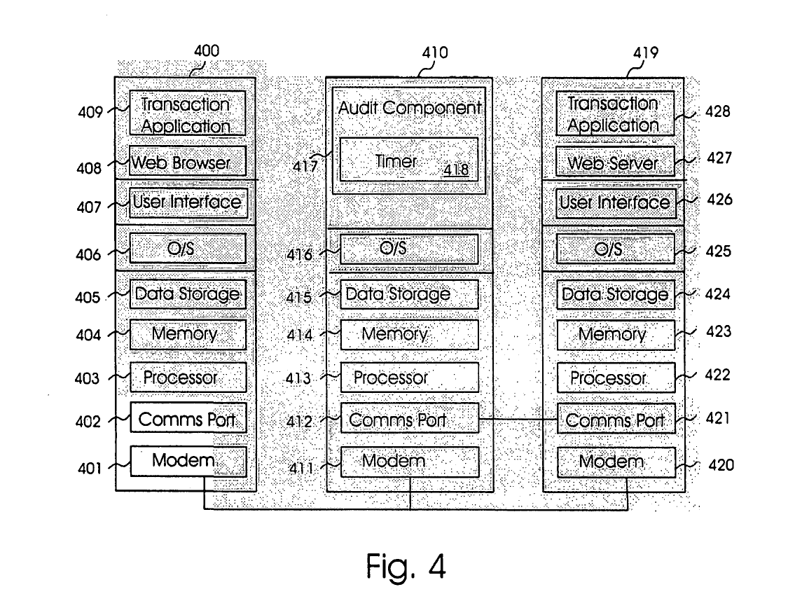

Referring to FIG. 4 herein, there is shown schematically components of the individual computer entities, FIG. 1.

User computer 400 comprises a modem 401 for communicating over a communications network; a communications port 402; a data processor 403, for example a known prior art data processor such as an Intel, AMD or like processor; a memory device 404; a data storage device 405, comprising for example a hard disk data storage device; a user interface 407, comprising a visual display monitor, a key board and a pointing device such as a mouse, track ball or the like; a web browser 408, for example a Net scape® web browser; and a transaction application 409. The transaction application 409 may comprise any transactional application, for example an e-banking application, or an e-government application for filing a tax return, or the like. The transaction application has a prior art facility for secure transmission, using for example the secure socket layer (SSL) protocol. The secure socket layer protocol is embedded in prior art operating systems, such as Microsoft Windows® 2000.

Secure protocol manager 410 comprises a modem 411; a communications port 412; a data processor 413; a memory device 414; a data storage device 415; a known operating system 416, for example Microsoft Windows®, Linux®, or Unixs®; and a firmware audit component 417, including a timer component 418. The secure protocol manager 410 is physically encased in a secure casing, for example an armored tamper proof box.

Web server computer entity 419 comprises: a modem 420; a communications port 421; a data processor 422; a memory device 423; a data storage device 424 for example a hard disk drive; an operating system 425, for example a known Microsoft Windows®, Linux®, or Unix operating system; a user interface 426, comprising a visual display monitor, a key board and a pointing device such as a mouse; a web server component 427 for generating a website; and a transaction component 428 for corresponding with transaction application 429. The transaction component 429 may fulfil any type of transactional function, for example receiving tax returns, and comprise an e-commerce or e-government engine for transacting business on-line, and uses the known secure socket layer protocol for communication with the transaction application 409.

The secure protocol manager 410 manages communication sessions between the entities, and additionally provides an audit trail of communications between entities. The Secure Protocol Manager is under control of the website computer entity, and may relieve the data processing load on the processor 422 of the web site computer entity, by carrying out much of the encryption and decryption functions on behalf of the website computer for transactions over the communications network and keeping the encryption keys of the website computer entity secret. In the best mode, the secure protocol manager uses the known secure socket layer protocol (SSL).

The secure protocol manager may be implemented as a hardware module, with its functionality being embedded in firmware. The module may be either integrated into a web server or web service channel with an appropriate automatic procedure instruction (API) to support an SSL session, or it could sit in between individual TCP/IP drivers and a web server application. The secure protocol manager may perform all parts of each SSL transaction, including an initial key exchange and session establishment procedure, through to session key management, and application of session keys. This means that encrypted data and SSL protocol messages go into the hardware module and the un-encrypted results can be read out by an application associated with the SSL session.

The secure protocol manager comprises a tamper proof hardware device, which assists the website in running an SSL session. The secure protocol manager generates keys for the SSL session, which are never released from the secure protocol manager, and allow a secure audit trail to be generated by the secure protocol manager apparatus.

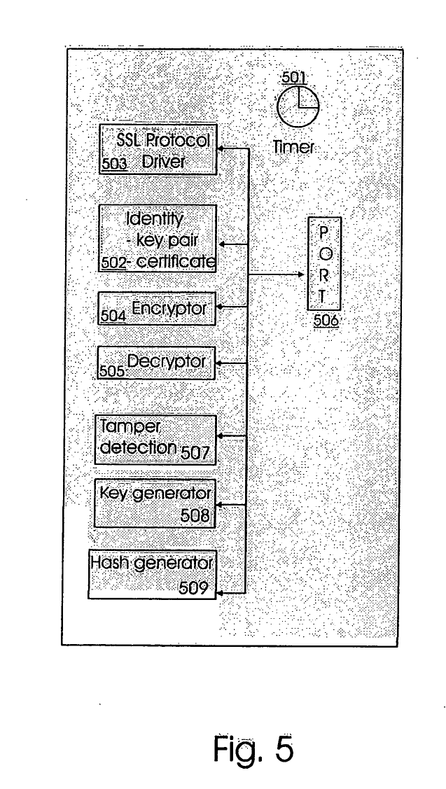

Referring to FIG. 5 herein, the secure protocol manager 500 is supplied to a website operator as a secure box, containing a timer device 501, and contains an identity 602 including a key pair and a certificate; an SSL protocol driver 503; an encryptor 504 and a decrypter 505; and a communications port 506 for communicating with a website computer entity; a tamper detection component 507 for detecting violation of the secure protocol manager device; a key generator 508 for generating one or more keys; a hash generator 509 for generating a one-way hash function of data comprising a communications session, said apparatus operable for producing a record of said secure communications session. The SSL protocol driver, encrypted, decrypter, timer and port may be implemented in firmware.

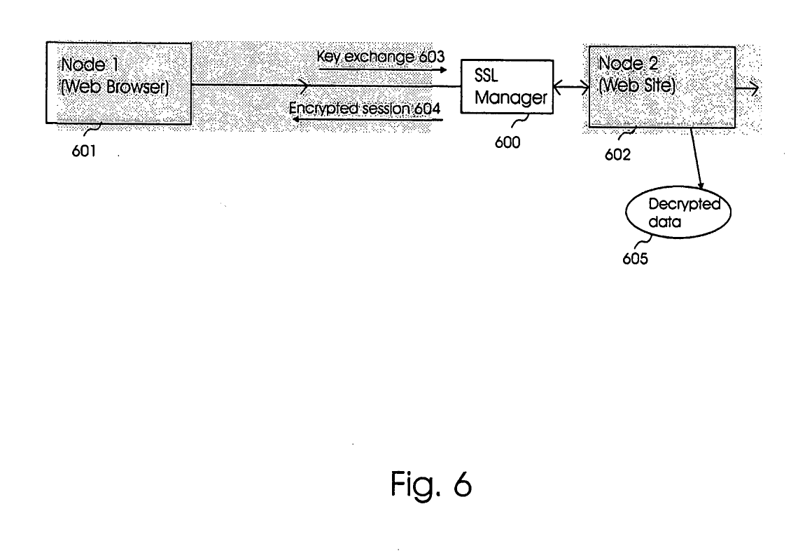

Referring to FIG. 6 herein, there is illustrated schematically the system of FIG. 3 re-drawn as logical entities, for the purpose of describing a method of operation of the system.

The secure protocol manager 600 comprises a consoled hardware item which has its own identity, in the form of a key pair and a digital certificate, and which can assign a further key pair to an SSL session.

The secure protocol manager device generates different sets of key pairs as follows. Firstly, the device generates a public key and private key for its own use, which it uses for signing audit records issued by the device. Secondly, the device can generate a public key and private key pair for an SSL session. Each time an SSL session commences, a new public key/private key pair may be generated by the secure protocol manager device. The keys may be verified by a separate certification authority, in known manner. The device needs a certificate, so that entities can trust the device, and that the box has the private key which matches the public key.

A human user uses web browser 601 to perform an operation of importance or monitory value, corresponding with website 602. The operation may be an E-commerce operation, an E-government operation or the like. The operator of the website wishes to be the user to their actions carried out on-line via the web browser. The SSL protocol is used to secure the interaction. Secure protocol manager apparatus 600 is positioned between the web browser and the website and is under control of the website.

An SSL session is initiated by a key exchange 603 followed by an encrypted session 604. In order to run an SSL session, the secure protocol manager 600 needs to generate some keys. The secure protocol manager hardware managers the entire session, including the key management.

Out of the website, is output-decrypted data 606, which is exactly the same as that input by the web browser entity. This functionality is integrated into the web server software. This can be done by a person having access to the web server software in one embodiment. In a best mode implementation, the above functionality is provided as a stand-alone component within secure protocol manager 500. In the best mode, the secure protocol manager sits between the web browser and the website.

Upon initial installation into a system, the secure protocol manager undergoes an installation an initialisation procedure, which connects the manager with a web server. The web site undergoes an initialisation phase in which the secure protocol manager is named, and a set of keys are generated.

A certificate request is then issued to a certification authority by a know mechanism, and in response to the certificate request, a certificate is received from the certification authority by the secure protocol manager. For example the certificate may be signed by Verisign.

The key pairs are generated within the secure protocol manager, so the secure protocol managers key is generated within the secure protocol manager and never leaves the secure protocol manager box. There is no problem in storing the keys within the secure protocol manager box, since there is no encrypted data stored within the secure protocol manager box. If the SSL key were lost, for any reason, then to recover the situation all that would need to be done is to replace the SSL key with a new key, certified by the certification authority (for example Verisign). Functionality of the secure protocol manager box would then be regained.

The encrypted session is sent using the secure public/private key pair, and the secure protocol manager decrypts the result of the session, which is output to the website, so that a transaction component of the website can use the commands and instructions input from the web browser and via the secure protocol manager, to carry out instructions subject to the commands sent by the web browser.

At the end of the session the web server makes a request for an audit record. Whenever one of the parties logs off or is timed out, an audit record can be requested and will be produced by the secure protocol manager.

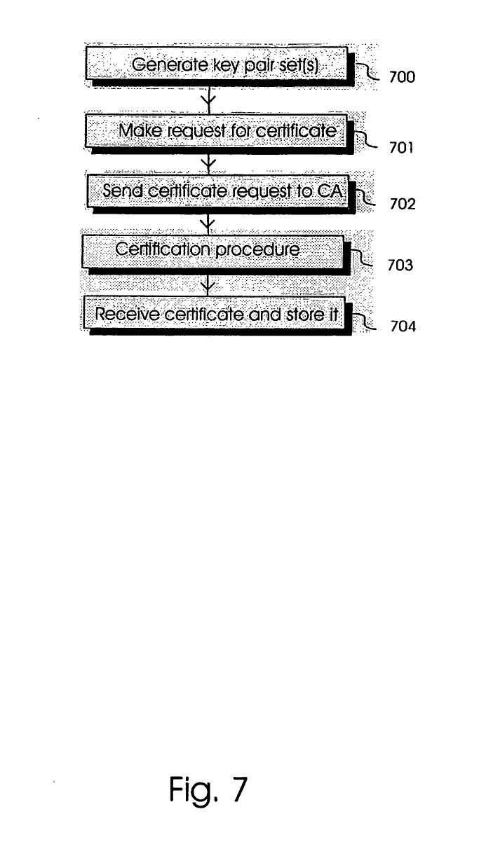

Referring to FIG. 7 herein, when a new secure protocol manager is installed and connected to a website server computer entity, as part of an installation procedure, the secure protocol manager undergoes an initialization phase. The initialization phase comprises generation of one or more sets of key pairs in process 700. Once the key pair set(s) are generated, the secure protocol manager identifies a certification authority computer, from pre-stored address data stored within the secure protocol manager at manufacture, and makes connection with a certification authority computer to make a request for a certificate in process 701. The certificate request is sent to the certification authority in step 702. In step 703, the secure protocol manager undergoes a certification process, communicating with the certification authority computer entity. In process 704, the secure protocol manager receives a digital certificate from the certification authority, and stores it in internal memory.

In order to accommodate the process of automatic request and certification by a third party certification authority, this may involve a certification authority modifying their charging practices to charge for such a service. After the initialisation, the secure protocol manager device will not release its key pairs, although it may under some circumstances share those key pairs under a sharing protocol, with other similar secure protocol manager devices.

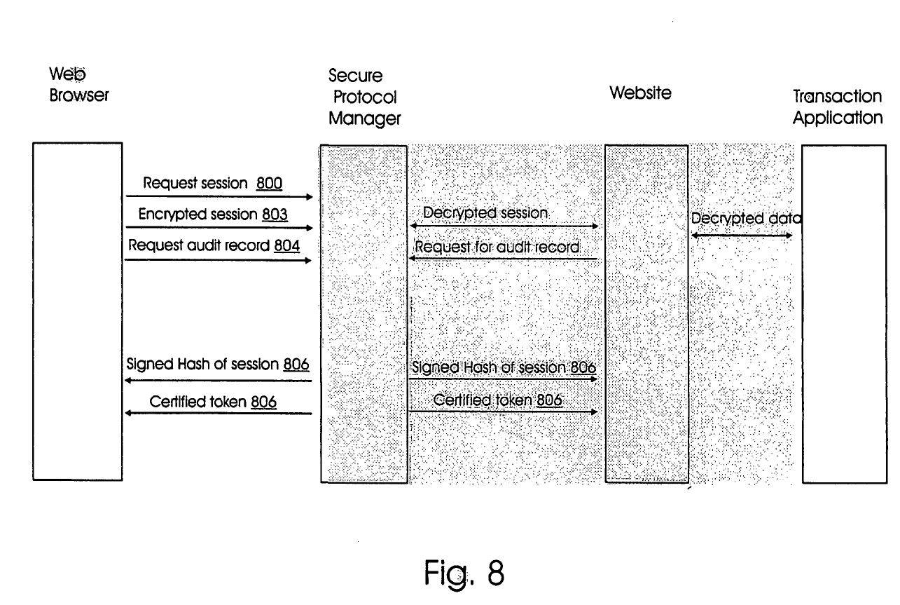

Referring to FIG. 8 herein, in process 800, web browser 801 requests a session from the website 802 via secure protocol manager 803. In process 801, the secure protocol manager generates a key set internally, and carries out an encrypted session with web browser 801 in process 803. The session is manages, so that the decrypted data from the session is sent to the website 802 over a secure link. Commands received from the web browser over an SSL channel are decrypted by the secure protocol managed, and the decrypted commands are sent to the website. Conversely, un-encrypted responses from the website are encrypted by the secure protocol manager and are sent to the web browser over the SSL channel.

Once the session is terminated, either by the web browser terminating the session, the website terminating the session, or the session becoming timed out through inactivity, either the website 802 an/or the web browser 801 can request an audit record from the secure protocol manager in process 804. The secure protocol manager generates an audit record in process 805 by generating a signed hash of the session, and a certified token. The signed hashed and certified token can be sent to a requesting party in process 806. Each party is given a copy of the signed hash and certified token, so that each party has a verifiable non-repudiable record of the session. The key pair representing the secure protocol management device itself is used to sign the hash at the end of the session, to provide the non-repudiation. Another key pair is used by the SSL session to run that session.

The secure protocol manager contains a data processor, a secure memory device, a hardware random number generator, a dock, and interfaces for interfacing with a website computer entity. Each secure protocol manager hardware device has its own public private key pair, and is certified by a service issuer as a trusted box, by the issuance of a certificate associated with this key pair. This certificate is used to validate audit trails generated by the secure protocol manager device.

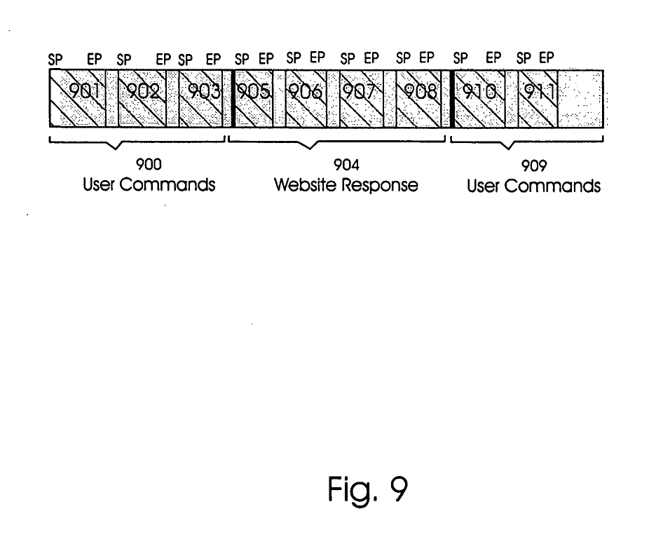

Referring to FIG. 9 herein, there is illustrated schematically communications made between a secure protocol manager device and a web browser during an SSL session. The communications are encrypted, however that either end of the SSL communications link, the commands and messages are decrypted. In FIG. 9, there is illustrated one section of an exchange between a user website and the secure protocol manager. In a typical session, many such exchanges may take place. A first user communication 900 between the user website and the secure protocol manager comprises the first user message 901 having a start point and an end point, a second user command having a start point and an end point, and a third user command 903 having a start point and an end point.

A website generated response set 904 comprises a first website response data 905 having a start point and an end point, a second website response data 906 having a start point and an end point, and a third website response data 907 having a start point and an end point and a forth website response 908 having a start point and an end point.

Each start point and end point has a start time, being a time during the day at which the message was started to be transmitted, and an end point, being a time during the day at which the message terminated, as measured by the secure protocol manager device.

A third user command set 909 comprises one or more user commands 910, 911 respectively each having a start point and an end point, where each start point and end point has a specific time associated with it as measured by the secure protocol manager device.

Upon send of each website response data by the secure protocol manager, a record of the start point time and the end point time is made, aswell as hash function being applied to that record.

For each message received by the secure protocol manager device, the device records a start point time, being a time at which that command or message began to be received by the secure protocol manager, according to its internal clock, and an end point time, being a time at which the command or message ceased being received by the secure protocol manager according to its internal clock, as well as a hash function, applied to the command or message at the time it was received by the secure protocol manager.

Thus, the secure protocol manager records for each message going into and out of that device a start time, an end time, and a hash function of the data content of that message or command, so that within a specified SSL session, there is a stored locally a complete record of communications into and out of the secure protocol manager box with start times, end times of each communication, as well as a hash function of the content of the communication where the start point and end point times are according to the timer within the secure protocol manager.

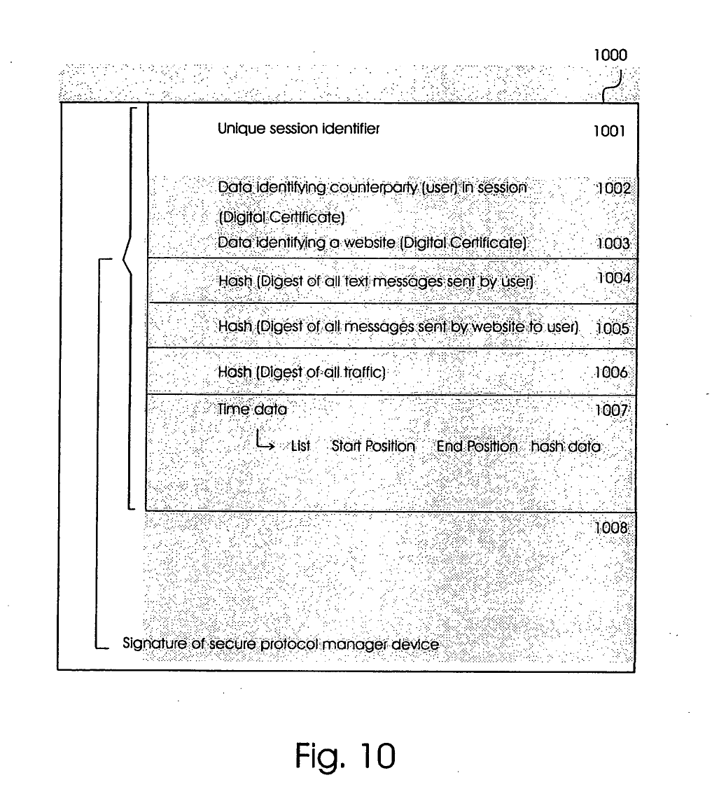

Referring to FIG. 10 herein, there is illustrated schematically an audit record of a session. The audit record comprises a session identifier data 1001, which uniquely identifies a user session, the session identifier data comprising data 1002 identifying a counter party in the session, for example by digital certificate, and data 1003 identifying a website, for example in the form of a digital certificate of that website; a digest of all the messages which a user has sent to the secure protocol manager in the session 1004, to which a first hash process is applied; a digest 1005 of all text messages sent by the website to the users web browser, to which a second hash process is applied; a digest 1006 of all traffic, that is the first digest and the second digest added, and to which a third hash process is applied; a time data 1007, the time data comprising a list of start position, an end position and hash data for each message between user and website and for each message between website and user. The whole of the audit record has a digital 1008 signature of the secure protocol manager applied to it.

The resultant audit record comprises a signed record, signed by the secure protocol manager of a session, and contains data uniquely identifying the session, uniquely identifying a user counter party in the session, data uniquely identifying a website or service provider in the session, and hash functions of all text messages sent by the user to the website, hash functions of all the messages sent by the website to the user, hash of all the traffic, and time data listing the start position, end position and the hash data for each of the messages sent.

Consequently, a person holding such an audit record can tell when the session took place, who the parties were in the session, and the times of each communication between parties within the session. They cannot discover the content of the messages between the counter parties, since these are protected by one-way hash functions. However, in a dispute, two counter parties, can compare their audit records of the same session, to check that the hash data is the same. This establishes at least that the parties have the same audit record.

Provided each party has kept a record of their transmissions, then under circumstances of a dispute, those transmissions can be subjected to a hash function, and the result of the hash function compared with the hash digest of those proported same transmission contained in the audit record. If the hash functions coincide, then this shows to a high degree of certainty, that the transmissions of that counter party proported to be made in the session were in fact made.

The control of the keys and their use within a tamper resistant secure protocol manager apparatus ensures that the session must have been handled within that, or an associated secure protocol manager device.

The secure protocol manager operates to provide a verifiable record of a secure communication session between first and second computer entities party to a secure communications session, by receiving from said first computer entity a first set of data transmissions comprising said communications sessions; receiving from second computer entity a second set of data transmissions comprising said communications session; storing said first set of data transmissions; storing said second set of data transmissions; generating a unique identifier data uniquely identifying said communication session; generating a data uniquely identifying said first and second sets of data transmissions; and generating an audit record data uniquely identifying said communications session, said first and second computer entity, and comprising said data uniquely identifying said data transmissions.

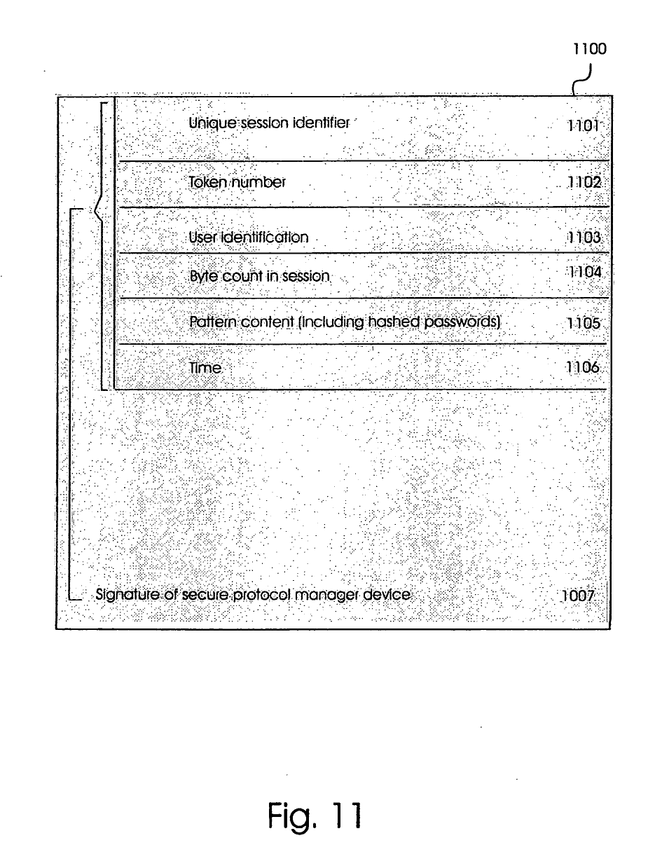

Referring to FIG. 11 herein, there is illustrated schematically an electronic certified token generated by the secure protocol manager device. A user of the secure protocol manager needs to record the messages which it has received and sent as part of the audit trail, and the certified token data acts as a validation of the users own record, providing a correct rendering of the session, as long as it matches what the secure protocol manager device itself has recorded.

The certified token comprises: a unique session identifier data 1101 uniquely identifying a session, a unique token number 1102, uniquely identifying that token: a user identification data 1103, uniquely identifying a user party; a byte count data 1104, specifying a number of bytes transmitted in the session; a pattern content data 1105, including hash pass word data; and a time data 1106, specifying start and step times at which the session was made. The complete token is certified by a digital signature 1107 of the secure protocol manager device.

The token is useful where it needs to be demonstrated that a particular user or website made a request via an SSL session. This may have been a programmatic request rather than from a web session. In this case, the secure protocol manager device may buffer such requests, and if the desired pattern of the request far token generated made by the user matches the given pattern of requests made in the session, then the secure protocol manager device issues a certified token as shown in FIG. 11, specifying that the user had issued that request. When a pattern of text received from a computer requesting a token matches a pattern of text stored in a buffer memory of the secure manager device then the secure manager device will release a token to that requesting computer entity. By pattern is meant a string a data, typically of text, which can be searched by an algorithm contained within the secure manager device, which compares a sequence of bytes of an incoming request data, with sequences of bytes stored in an internal buffer memory of the secure protocol manager device. The algorithm searches for matching patterns of bytes between the data stored in the internal buffer memory of the secure protocol manage device, and the data supplied from a computer entity requesting the issuance of a token. Any passwords which are received as requests from a webserver or from a website are blanked out using hashes. Such a token, or even a sequence of such tokens, can be passed to other applications to provide authorisation or an event based audit trail. A sequence of tokens may be used to demonstrate a user's identity, and their requested actions, particularly when a password-based log in to a website is used.

To avoid the problem that the pattern stored by the user their record of the content of a session could be used out of context, linking of a certified token to an overall session audit provides evidence that the pattern is not being used out of context.

The secure protocol manager device operates to provide a verifiable token record of a secure communications session between a first computer entity and a second computer entity by; during said communications session, storing data transmissions between said first computer entity and said second computer entity; on receiving a request data from a said computer entity, said request data comprising a byte count of data transmissions made by said computer entity, comparing said byte count of said data transmissions with a byte count of data transmission stored as said record of said communications session; and if said byte count of said received request matches a said byte count of said communications session, then generating a token data. The token data is sent to said requesting computer entity.

Since compromise of a key is a matter of concern for the website owner, one consequence of having a private key and SSL session capability in a separate item of hardware, i.e. the secure protocol manager device, is that it may allow a thief to more easily steal the identity of the server, by physically stealing the secure protocol manager hardware. This can be guarded against by several mechanisms. Firstly, the casing of the secure protocol manager device is designed to be armored, and may have a physically robust casing having drill holes enabling the casing to be bolted to a secure surface, for example a concrete floor in a building, that is to be physically secured in a building in a manner which makes the secure protocol manager difficult to remove. Secondly, the secure protocol manager device may run a start up routine which, when the device is powered up, before allowing operation of the device, requires certain security codes and, or passwords to be entered into the box, before access to the keys can be obtained.

As the operator of the website computer entity, there is no way that the website can access the secure protocol manager key, since this is stored within the secure protocol manager box and is inaccessible, since the box is designed to be tamper proof.

Whilst specific modes and implementations have been described using the Secure Socket Layer (SSL) protocol, in principle, the methods described herein may be applicable to a range of secure communications protocols, including for example the Microsoft TLS System. The scope of the invention is limited only by the features defined in the claims herein.

In FIGS. 3 to 10 herein, there is shown an implementation in which a secure protocol manager device is connected to a web server computer entity. However, in a further implementation, the secure protocol manager device may be provided to a sender of e-mails.

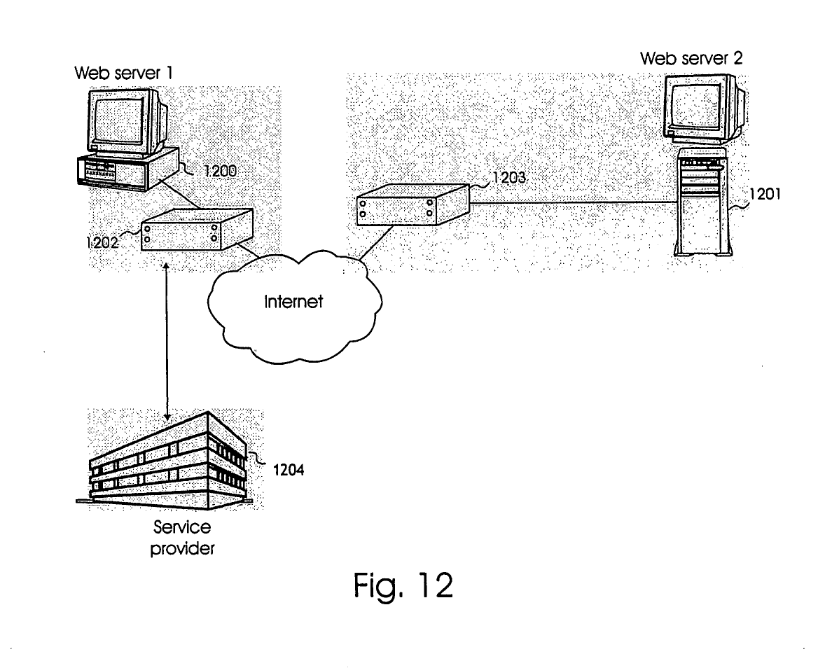

Referring to FIG. 12 herein, there is shown an implementation of a secure communications link, for example an SSL link, in which a web browser computer entity 1200 communicates with a web server computer entity 1201, and both the web browser computer and web server computer are each connecting to a corresponding respective secure protocol manager device 1202, 1203.

Either manager device 1202, 1203 on the client side or server side respectively are each capable of providing an audit record and audit token for an SSL session. An operator on the client side of the communication, that is the operator of the web browser 1200, may wish to audit the session using a secure protocol manager device, which they are certain can be trusted by them, as well as an operator on the server side auditing the session using their trusted secure protocol manager device. In scenarios where web servers contact other web servers and conduct SSL sessions between web servers, operators of each web server may wish to have their own secure protocol manger device, which is trusted by themselves, to maintain an audit record of secure protocol sessions.

Provision of the secure manager device is 1202, 1203 may be made to an operator of a web server, provided as a service.

In such a scenario, a service provider may hire or lend a secure protocol management device 1202 to an operator of a web server 1200, under a service contract for a specific time period, for the purposes of auditing an SSL session, or other secure protocol sessions carried out by the first web server 1200 with other computer entities. A third party service provider provides a secure protocol manager device 1202 to an operator of a web server. The secure manager device connects to the web server device and conducts secure communications sessions in the manner describe herein before. After a pre-determined period, the secure device is returned for inspection by the third party service provider 1204. The service provider ensures that the box has not been tampered with, by visual and electronic inspection, and the third party service provider will provide independent verification that the box has been issued to the operator of the first web server for a particular period, and that the box has not been tampered with. Therefore, as far as the operator of the second web server computer 1201 is concerned, or for anyone else who requires verification of the content of a secure session, or who may query the content of an audit record or token, the third party service provider is able to issue statements and assurances to interested parties, that the tokens and audit records issued by the device are true records of communication sessions. In order for parties to have confidence in the statements issued by the service provider, ideally the service provider is a well respected corporate or body, for example a large multinational corporation, having the capability and funding to obtain a high reputation for trustworthiness.

The service provider may issue a verification statement, to a third party querying the validity of an audit record or token, verifying that they have inspected the secure protocol manager device, found the secure protocol manager device to be intact and not having been interfered with or compromised in any way, and verifying that a particular audit record or token has been issued by the secure protocol manager device within a period in which the secure protocol manager device has been assigned to an operator of the first computer entity.

1. A method of operating a secure communications session, said method comprising:
generating a unique identifier data identifying said communications session;
storing a first unique identifier data identifying a first computer entity, party to said communications session;
storing a second unique identifier data identifying a second computer entity party to said communications session;
monitoring data communications between said first and second computer entities; and
generating a data uniquely identifying said data communications between said first and second computer entities.

2. The method as claimed in claim 1, wherein monitoring said data communications comprises:
storing in a buffer memory, data transmissions originating from said first computer entity and sent from said first computer entity to said second computer entity.

3. The method as claimed in claim 1, further comprising:
storing in a buffer memory, data transmissions originating from said first computer entity and sent from said first computer entity to said second computer entity;
applying a hash function to said data transmissions from said first computer entity to said second computer entity, said hash function uniquely identifying said data transmissions.

4. The method as claimed in claim 1, wherein monitoring said data communications comprises;
storing in a buffer memory, transmissions originating from said second computer entity and sent from said second computer entity to said first computer entity.

5. The method as claimed in claim 1, further comprising:
storing in a buffer memory, data transmissions originating from said second computer entity and sent from said second computer entity to said first computer entity;
applying a hash function to said data transmissions from said second computer entity to said first computer entity, said hash function uniquely identifying said data transmissions.

6. The method as claimed in claim 1, further comprising:
for each said data communication between said first and second computer entities, storing:
a start time of said data communication;
an end time of said data communication; and
a hash function of said data communication.

7. The method as claimed in claim 1, further comprising:
generating an audit record comprising;
said unique identifier data describing said communication session;
said first unique identifier data describing said first computer entity;
said second unique identifier data describing said second computer entity;
a data uniquely identifying a content of said data communications between said first and second computer entities; and
a signature verifying said audit record.

8. The method as claimed in claim 1, further comprising:
generating a token data, said token data comprising:
said unique identifier data uniquely identifying said communications session;
a data uniquely identifying said token;
a data identifying a said computer entity requesting said token;
a byte count data describing a number of bytes transmitted in said communications session; and
a time data specifying a start time and an end time of said communications session.

9. The method as claimed in claim 1, further comprising:
generating a token data, said token data comprising:
said unique identifier data uniquely identifying said communications session;
a data uniquely identifying said token;
a data identifying a said computer entity requesting said token;
a byte count data describing a number of bytes transmitted in said communications session;
a time data specifying a start time and an end time of said communications session; and
a signature of a device generating said token data.

10. The method as claimed in claim 1, further comprising:
at the end of said communications session, generating an audit token data, said audit token data providing a record of said communications sessions;
sending said audit token data to said first computer entity; and
sending said audit token data to said second computer entity.

11. The method as claimed in claim 1, further comprising:
receiving from a said computer entity, party to said communications session, a data record of data transmissions originating from said computer entity;
comparing said received data transmissions with stored data transmissions which were stored during said communication sessions;
if said received data transmissions are identical to said stored data transmissions, then generating a token data, said token data uniquely identifying said communication session, and verifying that said received data communications from said computer entity correspond with said stored data transmissions of said communication session.

12. A method of providing a verifiable record of a secure communication session between first and second computer entities party to said secure communications session, said method comprising;
receiving from said first computer entity a first set of data transmissions comprising said communications session;
receiving from said second computer entity a second set of data transmissions comprising said communications session;
storing said first set of data transmissions;
storing said second set of data transmissions;
generating a unique identifier data uniquely identifying said communication session;
generating a data uniquely identifying said first and second sets of data transmissions;
generating an audit record data uniquely identifying said communications session, said first and second computer entities, and comprising said data uniquely identifying said data transmissions.

13. A method of verifying a communications session between a first computer entity and a second computer entity, said method comprising:
during said communications session, storing data transmissions between said first computer entity and said second computer entity;
receiving a request data from a said computer entity, said request data comprising a pattern of data transmissions made by said computer entity;
comparing pattern of said data transmissions with a pattern of data transmissions stored as said record of said communications session;
if said pattern of said received request matches a said pattern of said communications session, then generating a token data; and
sending said token data to said requesting computer entity.

14. An apparatus for secure protocol management, said apparatus comprising:
a tamper proof container;
an input port and an output port, for connecting said device to a communications network wherein a secure communications session is transferred through said input and output ports;
a timer device for timing a secure communications session;
a key generator for generating at least one security key; and
a hash generator for generating a one-way hash function of data comprising a communications session, said apparatus operable for producing a record of said secure communications session.

15. The apparatus as claimed in claim 14, comprising:
a buffer memory configured for storing said data comprising a communications session.

16. The apparatus as claimed in claim 14, configured for operating to;
for each of a plurality of individual data transmissions comprising said communications session, store,
a start time of said data transmission;
an end time of said data transmission; and
for each said data transmission, said hash generator generating a one-way hash function of a data content of said data transmission.

17. The apparatus as claimed in claim 14, wherein, said apparatus is configured for:
identifying a password comprising data transmitted in said communications session; and
applying a hash function to said password.

18. An audit record data file for verifying a content of a secure communications session between a plurality of computer entities, said audit record data comprising:
data identifying said communications session;
data identifying a first computer entity involved in said session;
data identifying a second computer entity involved in said session;
data uniquely identifying a set of communications between said first and second computer entities; and
data identifying a timing of said communications between said first and second computer entities.

19. The audit record data file as claimed in claim 18, wherein said data describing communications between said parties comprises:
data identifying messages sent from said first computer entity party to said second computer entity party.

20. The audit record data file as claimed in claim 18, wherein said data describing communications between said parties comprises:
data identifying messages sent from said second computer entity party to said first computer entity party to said second computer entity party.

21. The audit record data file as claimed in claim 18, wherein said data identifying communications between said first and second parties comprises at least one hash function.

22. The audit data record data file as claimed in claim 18, stored on a physical data storage medium.

23. A method of initially configuring an apparatus for secure protocol management, said method comprising;
applying electrical power to said apparatus;
said apparatus generating a public/private key pair set, for use by said apparatus;
requesting a certificate from a third party computer entity;
receiving said certificate and storing said certificate;
said third party computer entity being identified in a pre-stored list of trusted computer entities.

24. A service of producing a verifiable record of at least one communications session carried out by a computer entity having a secure communications capability, said service comprising:
connecting a monitoring device to said computer entity, for monitoring said at least one communications session carried out by said computer entity;
said monitoring device storing a record uniquely identifying said at least one communications session carried out by said computer entity;
after said at least one communications session has been monitored by said monitoring device, carrying out an inspection of said monitoring device to ensure that said monitoring device has not been compromised; and
in response to a request for verification of said at least one communications session from a third party, issuing a statement verifying that said secure monitoring device has not been compromised.

25. The service as claimed in claim 24, wherein issuing a statement that said monitoring device has not been compromised comprises:
issuing a verification statement stating a time period of which said monitoring device has been assigned to said first computer entity; and
verifying that a said record was generated by said monitoring device during said period.

26. A tamper resistant device for providing an audit record of a communications session, said device comprising:
means for operating a secure communications protocol; and
means for producing an audit record of at least one secure transaction.

27. The device as claimed in claim 26, comprising:
a secure timer device;
a set of tamper detection circuits for detecting tampering with said device;
a protocol management component;
an encryption/decryption component; and
a secure key store.

28. The device as claimed in claim 26, having a unique identity which is generated at a time of creation of said device.

29. The device as claimed in claim 26, which has a unique identity which is generated at a time of configuration of said device, wherein said identity is certified and specifies a domain of control.

30. The device as claimed in claim 26, capable of matching a pattern within a message, and capable of replacing elements of said message with a hash function.

31. The device as claimed in claim 26, capable of:
matching a pattern within a message;
replacing elements of said message with a hash function; and
generating an audit data including a reference to a hashed data.

32. The device as claimed in claim 26, operable for generating an audit within a session, in which a token pattern is matched.

33. The secure device as claimed in claim 26, further comprising a means for recording details of a session conducted by said device.

34. A client system capable of verifying tokens generated by a secure device as claimed in claim 26, wherein a said token is generated based on a unique device identity generated at a time of configuration of said secure device.

35. A system comprising a plurality of devices as claimed in claim 26, wherein:
a first said device represents a first user;
a second said device represents a second user; and
session details are recorded by each of said first and second devices.

36. A system comprising a plurality of devices as claimed in claim 26, wherein:
a first said device represents a first user;
a second said device represents a second user;
session details are recorded by each of said first and second devices; and
tokens are distributed to both said users.

37. A method of auditing a secure communications session using a secure device, said method comprising:
operating a communications protocol in said secure device; and
producing an audit record of at least one transaction carried out by said secure device.

38. The method as claimed in claim 37, comprising:
certifying a unique identifier data uniquely identifying a said secure device said identifier data being generated at a time of configuration of said device; and
specifying a domain of control.

40. The method as claimed in claim 37; wherein said audit record is generated at an end of a user session.

41. The method as claimed in claim 37, wherein said audit record is generated before said user session has ended.

42. The method as claimed in claim 37, wherein said audit record comprises at least one element selected from the set:
a session identifier;
data identifying a participant in said session;
a hash of all messages sent within said session;
a hash of all messages sent by a first user in said session;
a hash of all messages sent by a second user in said session;
a time data;
a signature.

43. The method as claimed in claim 37, comprising:
matching a pattern within a message; and
replacing elements of said message with a hash function.

44. The method as claimed in claim 37, comprising:
matching a pattern within a message;
replacing elements of said message with a hash function; and
generating an audit data including a reference to hashed data.

45. The method as claimed in claim 37, comprising generating an audit within a session, in which a token pattern is matched.

46. The method as claimed in claim 37, comprising recording details of a session conducted by said device.

47. The method as claimed in claim 37, comprising verifying a token generated by a said secure device.

48. The method as claimed in claim 37, comprising:
representing a first user by a first at least one said secure device;
representing a second user by a second at least one said secure device; and
recording details of a said session at said first and second devices.

49. The method as claimed in claim 37, comprising:
representing a first user by a first at least one said secure device;
representing a second user by a second at least one said secure device;
recording details of a said session at said first and second devices; and
distributing tokens of said session to both said users.
